(19) United States
(12) Patent Application Publication
(10) Pub. No.: US 2025/0033442 A1
(43) Pub. Date: Jan. 30, 2025

(54) DOOR MODULE AND HOUSING ASSEMBLY OF A VEHICLE WINDOW LIFTER

(71) Applicant: Brose Fahrzeugteile SE & Co. Kommanditgesellschaft, Bamberg, Bamberg (DE)

(72) Inventors: Dominik HOFMANN, Baunach (DE); Peter HERZOG, Strullendorf (DE)

(21) Appl. No.: 18/715,839

(22) PCT Filed: Nov. 30, 2022
(86) PCT No.: PCT/EP2022/083806

§ 371 Date: Jun. 3, 2024

(30) Foreign Application Priority Data
Dec. 1, 2021 (DE) 10 2021 213 597.8

(51) Int. Cl. B60J 5/04; E05F 11/48; E05F 15/689

(52) U.S. Cl. CPC B60J 5/0416; E05F 11/486; E05F 15/689; E05Y 2201/10; E05Y 2201/654; E05Y 2201/664; E05Y 2600/61; E05Y 2600/626; E05Y 2600/632; E05Y 2800/205

(57) ABSTRACT

A door module for a motor vehicle door includes a support panel with a window lifter cable drive mounted or mountable thereon and coupled to a cable drum for a pull cable connected or connectable to a pane carrier. A first housing part receives the cable drum and includes through-openings for screw elements. A second housing part paired with the cable drive has screw bosses corresponding to the through-openings. The first housing part is on a first panel side and the second housing part is on an opposite second panel side. Each screw element has a screw head with a first tool receptacle and a threaded shaft with a shaft tip and a second tool receptacle on or in the shaft tip, so that each screw element can be actuated on the second panel side to uninstall the second housing part screwed with the first housing part.

The invention relates to a door module for a vehicle door of a motor vehicle, having a cable drive of a window lifter or of a window lifter assembly, which is mounted or can be mounted on a support panel, and having a first and a second housing part, which are arranged on different sides of the support panel and are screwed together or can be screwed together by means of screw elements. The invention also relates to a housing assembly of a vehicle window lifter, which has the two housing parts which can be screwed together or are screwed together.

A vehicle door of a motor vehicle generally has a door frame, which is often referred to as a door shell, and a door outer panel which forms the door outer skin of the vehicle door, and a door inner panel, or a door inside trim, which is on the vehicle-interior side and is connected to the door frame. Between the door outer skin (the door outer panel) and the door inside trim, a hollow space is formed as installation space for functional elements or functional components of the vehicle door.

The functional components of a vehicle door, for example, a window lifter or a window lifter assembly, a pressure sensor for a side air bag, a door control electronics system, a loudspeaker, a door lock, control units or the like, are generally preassembled on a support panel of a door module, which is also referred to as an assembly support. The equipped support panel is subsequently attached to the door shell under a covering of a bracing of the door frame, which is also used as a mounting opening. The door module, as, in particular, a support panel equipped with the winder lifter (the window lifter assembly) is also used, in particular, for separating a wet chamber, which is formed between the door outer skin (the door outer panel) and the door module, and a dry chamber of the vehicle door, which is formed between the door module and the door inside trim (the door inner panel).

Such a window lifter for a vehicle door is designed, for example, having a cable system for raising and for lowering a (window) pane. Single-stranded window lifters having only one guide rail (single-strand application) or double-stranded window lifters having two parallel guide rails (double-strand application) can be used. Such a window lifter, which is also referred to as a cable window lifter, has at least one rail slider or (pane) carrier, which is connected to the (window) pane and is guided along the at least one guide rail by means of a driven cable system. The cable system of the window lifter generally has a cable pull, which is formed from at least one pull cable and, at one end, wraps around a cable drum, typically with multiple windings, and is wound and unwound by the cable drum, and which, at the other end, is guided, being deflected multiple times, at the or each (pane) carrier or rail slider, and is fixed there.

As a window lifter drive or cable drive, an electric motor having a coupled gear mechanism, in particular a worm gear as a 90°-deflection mechanism, is typically provided. In the single-strand application, the cable drive is mounted on the support panel of the door module and is spaced apart from the individual guide rail, while in the double-strand application having two parallel guide rails, the cable drive is typically arranged between the two guide rails of the door module and mounted on the support panel.

When the cable drive is installed, the electric motor can be arranged on the wet-chamber side (wet-chamber motor) or on the dry-chamber side (dry-chamber motor). The electric motor with the gear mechanism coupled thereto is typically installed by screwing a gear mechanism housing together with a housing part which accommodates the gear mechanism coupled to the electric motor, and with a housing part which accommodates a cable drum coupled to the cable drive. The housing parts of the housing assembly can be screwed together via through-openings in the support panel by means of screw elements (screws), wherein the screw heads are provided in the wet-chamber-side housing part and the screw threads are provided in the dry-chamber-side housing part or are placed therein when the housing parts are screwed together. Such a housing assembly of an electric-motor-dariven cable drive of a vehicle window lifter is known, for example, from DE 10 2016 212 041 B4.

A first housing part, which accommodates the cable drum coupled to the cable drive, can be arranged on the wet-chamber side, while a second housing part, which accommodates the gear mechanism coupled to the electric motor, is arranged on the dry-chamber side of the support panel. The housing parts must therefore be screwed together from the wet-chamber side toward the dry chamber, whereby the two housing parts, which have been screwed together, can no longer be separated, for example, when the electric motor and/or the gear mechanism of the cable drive must be uninstalled for repair, since the screw elements, or screws, are no longer accessible. In addition, when the electric motor is defective, the typically self-locking gear mechanism of the cable drive prevents the window pane from being moved, or lowered, in order to release the mechanical interface or connection of the window pane with the (pane) carrier or rail slider of the window lifter and, in order to uninstall or repair the electric motor, to remove the door module, or the support panel, with the installed window lifter from the vehicle door.

The problem addressed by the invention is that of providing a particularly suitable door module having a window lifter, which is mounted on a support panel, for a vehicle door, wherein it is to be ensured that two housing parts of a housing assembly of an electric-motor-driven cable drive of the window lifter can be screwed together from a dry-chamber side and/or from a wet-chamber side of the door module. In particular, disconnecting the screw connection, for example, in order to uninstall and/or repair the cable drive, from the dry-chamber side is to be permitted. Moreover, a particularly suitable housing assembly having two housing parts of a cable drive of a vehicle window lifter, which can be screwed together, is to be provided.

With respect to the door module, the aforementioned problem is solved according to the invention by the features of claim 1 and with respect to the housing assembly by the features of claim 10. Advantageous embodiments and developments are the subject matter of the dependent claims.

The door module, which is provided for a vehicle door of a motor vehicle and is designed, in particular, to separate the wet chamber and the dry chamber in the vehicle door, has a support panel for a window lifter assembly, which is also referred to in the following as a window lifter or a window lifter system and includes an electric-motor-driven cable drive which is coupled to a cable drum for a pull cable which is connected to a pane carrier, or a rail slider, which is slidably guided without a rail or, preferably, along a guide rail. A first housing part having a number of through-openings for screw elements rotatably accommodates the cable drum. A second housing part, which is associated with the cable drive, has a number of screw bosses for accommodating the screw elements, which number corresponds to the number of through-openings in the first housing part. The second housing part of the cable drive is preferably a gear mechanism housing, to which the electric motor is connected, for example, by means of a screw fastening or a screw connection as a mechanical interface.

The first housing part is also referred to in the following as a cable drive housing or as a (cable-) drum-side housing (part). The second housing part is also referred to in the following as a gear mechanism housing, as a (motor) drive housing, or as a drive-side or motor-side housing (part).

The first housing part (cable drive housing) and the second housing part (motor drive housing or gear mechanism housing) form a housing assembly which can be screwed together or is screwed together. Advantageously, both housing parts, in particular the motor-side second housing part, are made of plastic, for example, as an injection-molded part. The cable-drum-side first housing part (cable drive housing) is arranged on a first panel face of the support panel. The motor-side second housing part (motor drive housing) is arranged on a second panel face of the support panel, which is opposite the first panel face. Preferably, the cable-drum-side first housing part is arranged on or at the wet-chamber side, which corresponds to the second panel face, and the motor-side second housing part is arranged on or at the dry-chamber side of the support panel, which corresponds to the first panel face.

Suitably, the support panel has a number of plug-through openings which align (on one side) with the through-openings in the first housing part, which accommodates the cable drum, and (on the other side) with the screw bosses of the motor-side second housing part.

The screw element has a screw head which has a first tool receptacle, which preferably acts as a primary drive, and a threaded shaft which has a shaft tip at the shaft end (facing away from the screw head). The thread can be preformed metrically or in another way. Advantageously, the thread of the screw element is self-cutting. On or in the shaft tip, i.e., on the end face of the shaft end facing away from the screw head, a second tool receptacle is provided or is introduced into the shaft tip, the second tool receptacle preferably acting as a secondary drive.

Suitably, the second tool receptacle is formed on the shaft tip of the screw element as an internal or external polygon or as an inner multi-round, in particular as an internal or external hexagon, or a hexalobular. A slot or a cross slot can also suffice as a second tool receptacle when only a correspondingly low torque (loosening torque) is typically necessary to release the screw connection. Preferably, the second tool receptacle at the shaft tip of the screw element has an inner diameter of 3 mm to 5 mm, preferably (3.5+0.5) mm, in particular 3.5 mm or 4 mm. In addition, the secondary drive can be introduced into an additionally formed (cylindrical) shaft tip (without a thread), for example, also having a greater core diameter than that of the adjoining thread.

The second tool receptacle preferably acts as a secondary drive in order to actuate—i.e., loosen or tighten—the screw element not only from the screw head, but rather also from the opposing screw tip (by means of a tool). In other words, the screw element can be actuated, in particular loosened, on the second panel side in order to uninstall the motor-side second housing part, which is screwed together with the cable-drum-side first housing part. As a result, the screw connection, in particular a loosening of the screw connection, of the housing assembly is always accessible from the dry-chamber side of the door module, or on the dry-chamber side, in particular in order to uninstall the cable drive and/or to repair the electric motor, for example, its motor electronics system.

In an advantageous embodiment, the first housing part has plug-in pins which are penetrated by the through-openings for the screw elements. Advantageously, the screw bosses in the second housing part have (sunken) insertion pockets for accommodating the corresponding plug-in pin on the first housing part. As a result, the two housing parts can be advantageously joined, in particular interlockingly, (temporally) prior to being screwed together, which facilitates assembly and increases the fail-safety. Suitably, the first housing part has three through-openings and/or hollow plug-in pins, which are arranged in the region of the corners of a triangle or positioned in a triangular arrangement. Similarly, the second housing part has screw bosses, which are positioned in an identical triangular arrangement. In addition, for example, four such through-openings or screw bosses can be provided in the housing parts.

The thread of the screw element can extend over the entire threaded shaft or screw shaft from the screw head to the screw tip. In this design, it is advantageous when the inner width (the inner diameter) of the through-opening in the first, cable-drum-side housing part is at least slightly larger than the outer diameter of the threaded shaft, thereby preventing the thread from cutting or engaging into the through-opening, and the two housing parts can be properly pulled toward one another and assembled to form the housing assembly.

In a suitable embodiment, it is provided that the threaded shaft of the screw element has a first shaft portion which adjoins the screw head and has a first outer, core or shaft diameter, and a second shaft portion which leads into the shaft tip and has a second outer, core or shaft diameter. Preferably, the (outer) diameter of the first shaft portion is smaller than the (outer) diameter of the second shaft portion.

In this way, the screw element can be retained, when loosened via the second tool receptacle, on the shaft tip of the screw element in the associated through-opening, or in the plug-in pin on the first housing part, in a captive manner, for example, in an interlocking or clamping manner. As a result, the screw element is prevented from undesirably dropping into the wet chamber, for example, within the framework of uninstalling or repairing the drive or the electric motor, which wet chamber is not readily accessible after the vehicle door has been produced or after the door module has been installed. In addition, the two housing parts can be screwed together from the dry-chamber side without (completely) uninstalling the door module after repair work has been carried out or for the purpose of replacing the cable drive or its electric motor.

When the two housing parts are screwed together (for the first time), the comparatively small outer diameter or shaft diameter of the first shaft portion enters the through-opening, or the plug-in pin, in the first housing part (cable drive housing) as the two housing parts are screwed together, wherein a thread engagement does not occur there and the two housing parts are properly pulled toward one another.

The housing assembly, which is provided and designed, in particular, for a door module of a vehicle door of a motor vehicle, has a first and a second housing part, wherein the first housing part is provided and designed for accommodating a cable drum of a cable window lifter, while the second housing part is associated with the cable drive, which is formed from an electric motor having a gear mechanism coupled thereto. The first housing part has a number of, preferably three, triangularly arranged through-openings, with each of which a screw boss of the second housing part aligns. The screw bosses are used to accommodate and screw the screw elements, which are inserted via the through-openings in the first housing part, together with a threaded shaft and with a tool receptacle on both shaft ends, in particular on a screw head and on a shaft tip or screw tip. As a result, the screw element can be accessed in order to be actuated, in particular for tightening or loosening the screw connection, on both shaft ends, in particular from the rear face of the first housing part and of the second housing part.

Exemplary embodiments of the invention are described in greater detail in the following by reference to a drawing, wherein:

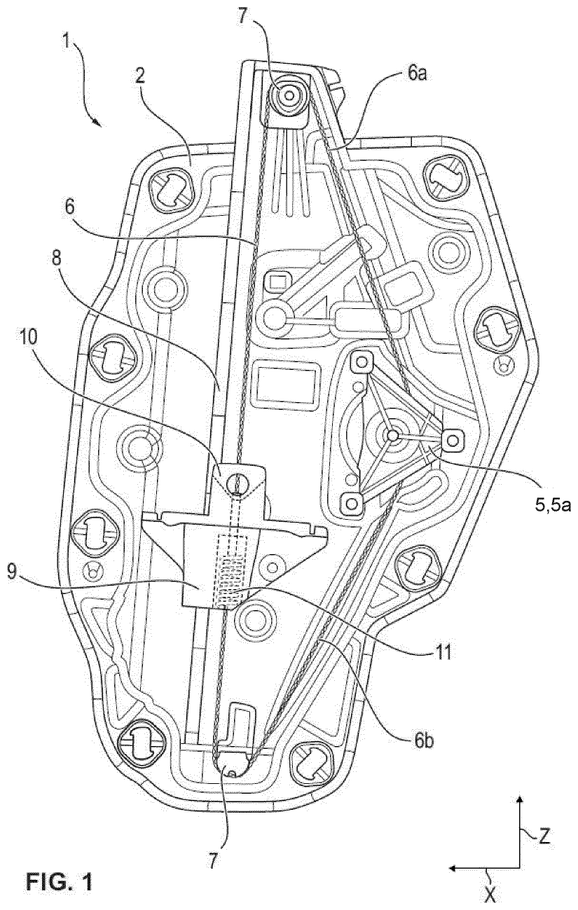

FIG. 1 shows, in a schematic view, a door module having a (vehicle) window lifter (cable window lifter) with a cable drive at or on a support panel, and having a guide rail with a (pane) carrier, which can be coupled to a window pane, or rail slider with a carrying function for the window pane,

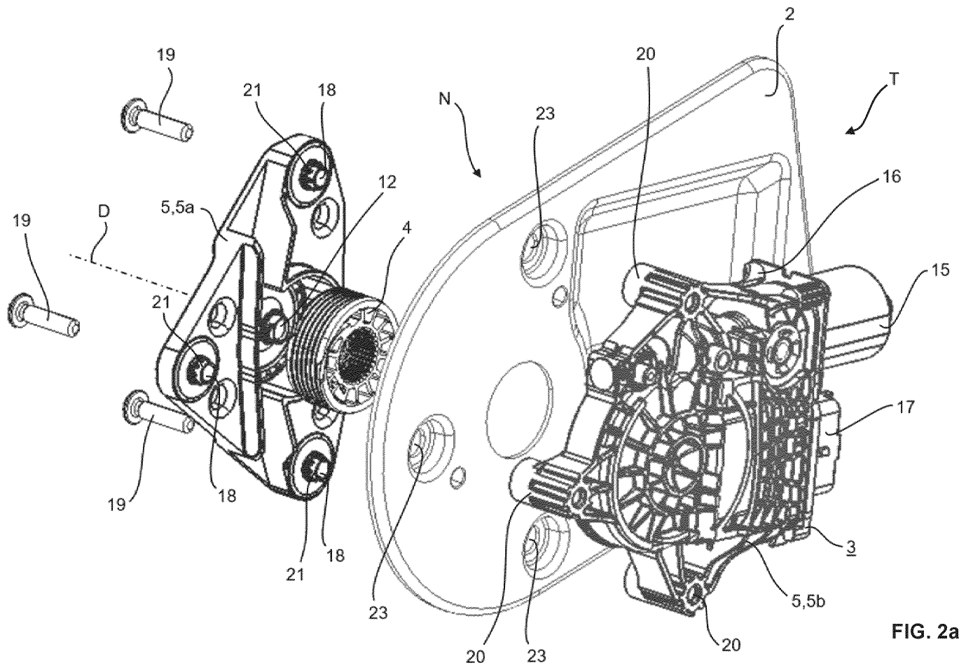

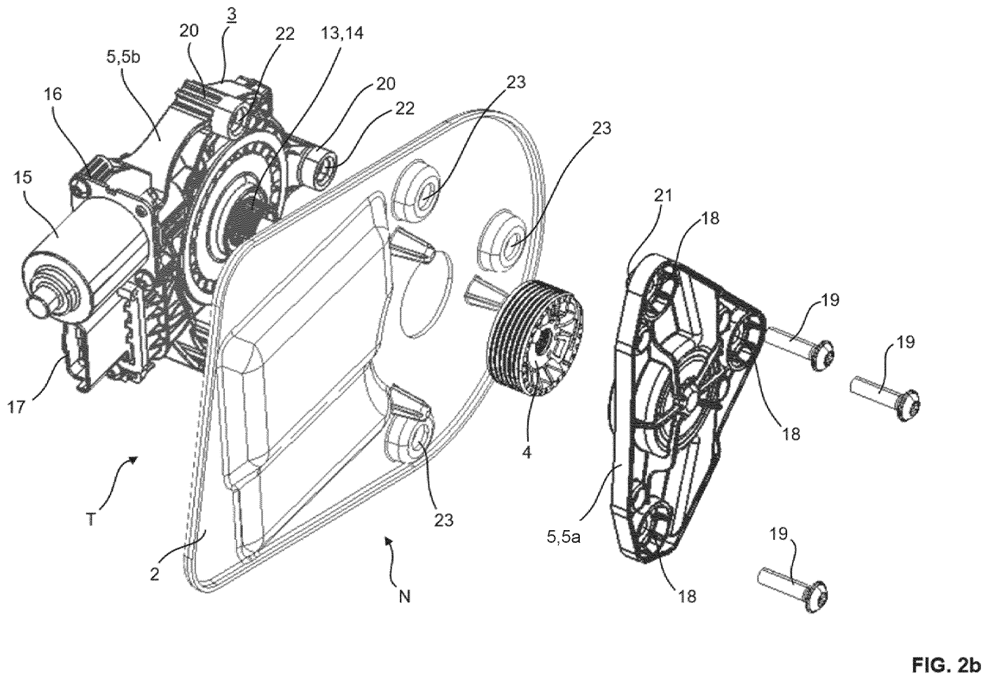

FIGS. 2a and 2b show, in an exploded view, the cable drive and the support panel of the door module and a housing assembly having the first housing part (cable drive housing) and having a second housing part (gear mechanism housing of the cable drive) with a view of a dry-chamber side and a wet-chamber side,

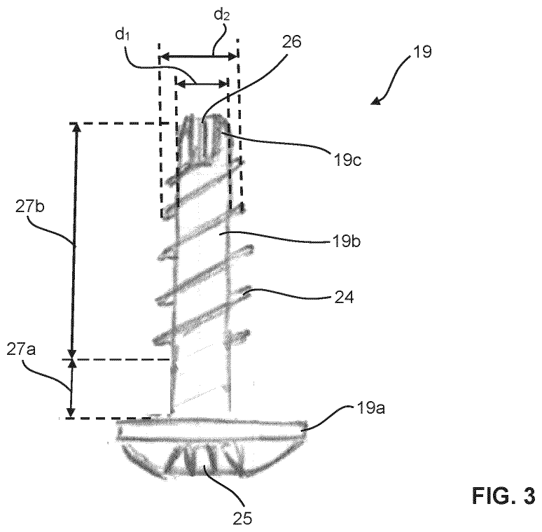

FIG. 3 shows, in a side view, a screw element having a tool receptacle at each end (primary and secondary drives) for screwing the two housing parts together and for loosening a screw connection, and

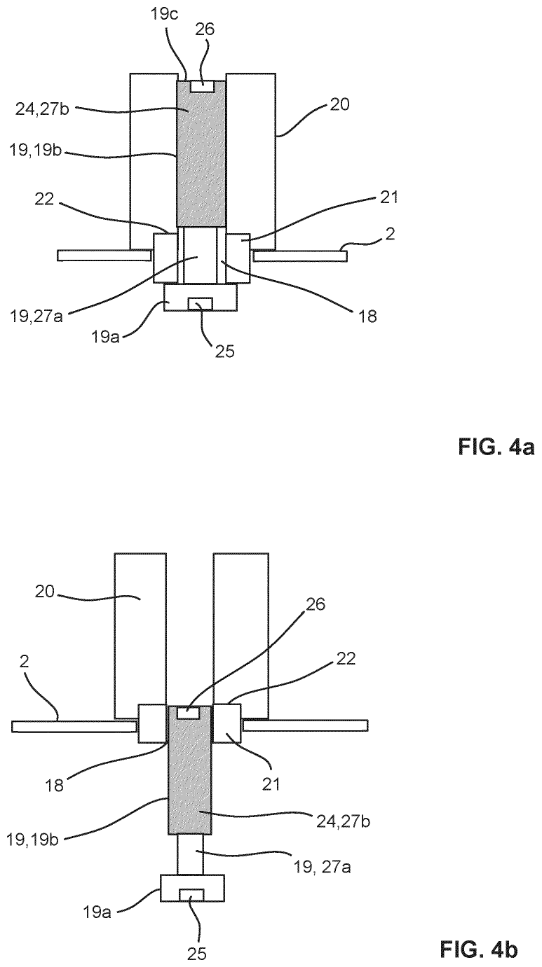

FIGS. 4a and 4b schematically show, in a sectional view, the screw element, which is screwed into and unscrewed from a screw boss in the second housing part via a through-opening and/or a hollow plug-in pin of the first housing part.

Mutually corresponding parts and physical quantities are provided with the same reference characters in all figures.

FIG. 1 shows a door module 1 having a window lifter, or a window lifter assembly, which is single-stranded in the exemplary embodiment and is mounted on a support panel or a functional support 2 as a support structure for installation in a vehicle door of a motor vehicle. The window lifter has a cable drive 3, which is shown in FIGS. 2a and 2b. The cable drive 3 rotationally drives a cable drum 4. The cable drum 4 is arranged in a first housing part 5a of a housing assembly 5, which is referred to in the following as a cable drive housing. A pull cable 6 of the window lifter is moved by means of the cable drum 4.

The pull cable 6 wraps around the cable drum 4, forming an incoming cable portion 6a and an outgoing cable portion 6b. The designation 6a, 6b of the incoming and the outgoing cable portions, respectively, relates to one of the two directions of rotation of the cable drum 4 in this case. In order to guide the pull cable 6, deflection elements 7 are provided, which are designed, for example, as cable rollers or deflection rollers and are arranged at rail ends of a rail contour of the support panel 2 or as a guide rail 8 mounted on the support panel 2. Arranged on this guide rail 8 so as to be displaceable in the z-direction are a (pane) carrier or rail slider 9 of the window lifter, which is connected or can be connected to a window pane, which has a clamping-jaw-like driving contour 10 for the window pane 30 (vehicle window), which is not shown.

The specifications regarding the spatial directions are indicated in a coordinate system of the motor vehicle (vehicle coordinate system) with respect to the exemplary installation situation in a side door of the motor vehicle. The x-axis is oriented along the longitudinal direction of the vehicle, the y-axis is oriented along the transverse direction of the vehicle and the z-axis is oriented along the vertical direction of the vehicle. The y-axis is normal (perpendicular) to the plane of the drawing in FIG. 1. With respect to the vehicle coordinate system, the support panel 2 lies in the xz-plane and the axis of rotation D (FIGS. 2a and 2b) of the cable drum 4 is oriented orthogonal thereto in the y-direction. The following specifications regarding the axial direction (axial) and the radial direction (radial) relate to the axis of rotation D of the cable drum 4, which is oriented in the y-direction.

The driver, or rail slider 9, is connected to the pull cable 6, and therefore a movement of the pull cable 6 induces a displacement of the rail slider (driver) 9 along the guide rail 8. Furthermore, the driver 9, or the rail slider, holds, by means of its driver contour 10, the window pane, which is carried along and moved when the rail slider or driver 9 is moved. The pull cable 6 is connected to the rail slider (driver) 9 via a spring element 11, which is arranged in the rail slider (driver) 9, in order to tension the pull cable 6 with a certain and predefined cable tension.

The window lifter in the exemplary embodiment does not have a Bowden cable, i.e., this is a cable window lifter with an open cable system. A Bowden cable system can also be provided, however. The window lifter can also have a two-stranded design with two parallel guide rails 8, which are formed from the plastic material of the support panel and are mounted on the support panel 2 of the door module 1 or integrated into the support panel 2, wherein the cable drive 3 in this case is preferably arranged between the guide rails or mounted on the support panel 2.

FIGS. 2a and 2b show exploded views of the cable drive 3 and, in sections and schematically reduced, the support panel 2 of the door module 1 and the housing assembly 5 having the first housing part 5a and having a second housing part 5b, which is also referred to in the following as a gear mechanism housing.

FIG. 2a provides a view into the cable drive housing as a first housing part 5a and of a first panel face of the support panel 2, which faces a dry chamber T or is located therein, and of the rear face of the second housing part 5b of the cable drive 3. FIG. 2b provides a view into or of the gear mechanism housing as a second housing part 5b and of a second panel face of the support panel 2, which faces a wet chamber N or is located therein, and of the rear face of the first housing part 5a as a cable drive housing.

FIGS. 2a and 2b show the cable drum 4, which is seated (on the output side) on a bearing journal 12 of the cable drive housing as a first housing part 5a and, there, is mounted so as to be rotatable about the axis of rotation D. The cable drum 4 is coupled (on the drive side) to a drive journal 13, which is coupled to a gear mechanism 14 which acts as a 90°-deflection mechanism in the form, preferably, of a worm gear. The gear mechanism 14, which is an integral part of the cable drive 3, is coupled to an electric motor 15, which is mounted via a motor/gear mechanism interface 16 on the gear mechanism housing as a second housing part 5b. A plug-in connection 17 is used to energize a motor electronics system and to control the electric motor 15 of the cable drive 3.

The first housing part (cable drive housing) 5a, which rotatably accommodates the cable drum 4, has a number of, namely three in the exemplary embodiment, through-openings 18 positioned in a triangular arrangement, one through-opening being associated with each screw element 19. The through-openings 18 correspond to, or align with, screw bosses 20 in the second housing part (gear mechanism housing) 5b, into which screw bosses 20 the screw elements 19 can be turned (screwed). The first housing part (cable drive housing) 5a and the second housing part (motor drive housing or gear mechanism housing) 5b form the housing assembly 5, which can be screwed together by means of the screw elements 19. The two housing parts 5a, 5b, in particular, however, the motor-side second housing part 5b, are/is made of plastic. The first housing part 5a has plug-in pins 21 which are penetrated by the through-openings 18 in the screw elements. The screw bosses 20 in the second housing part 5b have insertion pockets 22, which are sunken in the longitudinal direction of the screw elements, for accommodating the corresponding plug-in pins 21 on the first housing part 5a. As a result, the two housing parts 5a, 5b can be reliably, preferably interlockingly, joined prior to being screwed together. The support panel 2 has plug-through openings 23, through which the screw elements 19 can be passed or inserted, which plug-through openings align with the through-openings 18 and with the hollow plug-in pins 21 on the first housing part 5a, which accommodates the cable drum 4, and with the screw bosses 20 and with the insertion pockets 22 in the motor-side second housing part 5b.

FIG. 3 shows the screw element 19 with a self-cutting thread 24. With this thread design, the screw element 19 automatically cuts into the screw boss 20 in the second motor-side or drive-side housing part 5b. The first housing part (cable drive housing) 5a and the second motor-side housing part 5b—with the support panel 2 positioned therebetween—are pulled together and screwed together to form the housing assembly 5.

The screw element 19 has a screw head 19a with first tool receptacle 25, which is also referred to in the following as a primary drive, and a threaded shaft 19b and a shaft tip 19c on the shaft end (facing away from the screw head). A second tool receptacle 26, as a secondary drive, is introduced into the screw element 19 at or in the shaft tip 19c or on the end face of the shaft end facing away from the screw head 19a. This second tool receptacle 26 at or in the shaft tip 19c of the screw element 19 is in the form, for example, of a hexagon socket or a hexalobular (Torx), in particular having a diameter (inner diameter) of 3.5 mm or 4 mm. Via this second tool receptacle 26, the screw element 19 can be actuated from the dry-chamber side T by means of an appropriate, compatible tool, and therefore the screw connection of the two housing parts 5a and 5b of the housing assembly 5 of the cable drive 3 can always be disconnected on the or from the dry-chamber side T.

The threaded shaft 19b of the screw element 19, or the shaft of the screw element 19, has a first shaft portion 27a which adjoins the screw head 19a and has a first outer diameter (core diameter or shaft diameter) d₁ and a second shaft portion 27b which leads into the shaft tip 19c and has a second outer diameter (core diameter or screw diameter) d₂. The (outer) diameter d₁ of the first shaft portion 27a is smaller in relation to or in comparison to the (outer) diameter d₂ of the second shaft portion 27b, for example, by way of this first shaft portion 27a being threadless and/or the diameter of the shaft core of this first shaft portion 27a being smaller than that of the second shaft portion 27b.

FIG. 4a shows, in sections and schematically, or in a sectional view, the screw connection in one of the screw bosses 20 of the drive-side or motor-side second housing part 5b with the joining connection of the corresponding plug-in pin 21 on the cable-drum-side first housing part (cable drive housing) 5a with or in the insertion pocket 22 of the corresponding screw boss 20. The screw element 19 has a metric (external) thread 24 in this case, by way of example. A threaded bushing is then arranged in the screw boss 20, for example, the threaded bushing having an internal thread which corresponds to the (external) thread 24 of the screw element 19.

In the screw connection, the first shaft portion 27a having the reduced or tapered outer diameter d₁ of the screw element 19 is located in the region of the through-opening 18, or in the plug-in pin 21 on the first, cable-drum-side housing part 5a. Due to the fact that the inner diameter of the through-opening 18 and/or of the plug-in pin 21 is greater than the (outer) diameter of this first shaft portion 27a of the screw element 19, a screw connection is not established in the region of the through-opening 18 or of the plug-in pin 21 on the first, cable-drum-side housing part 5a, and the two housing parts 5a and 5b can be pulled toward one another, or braced, when these are screwed together.

FIG. 4b illustrates the loosened stated of the screw element 19, in which the screw element 19 is actuated via the secondary drive, i.e., the tool receptacle at the tip 19c, and is unscrewed from the screw boss 20. The screw element 19 is still visible with the shaft tip 19c in the through-opening 18 or in the plug-in pin 21 on the cable-drum-side, first housing part (cable drive housing) 5a. For this purpose, the through-opening 18, or the plug-in pin 21, can have inwardly directed ribs or webs, for example, as interlocking elements, in order to hold the screw element 19, in particular in an interlocking and/or clamping manner, i.e., captively, at or in this position in the through-opening 18 or in the plug-in pin 21 on the cable-drum-side first housing part (cable drive housing) 5a. In this way, the dry-chamber-side cable drive 3 or its electric motor 15 can be reinstalled after having been uninstalled and/or repaired, with the screw connection of the two housing parts 5a and 5b being established on or from the dry-chamber side T.

When the screw element 19 is loosened via the second tool receptacle 26 on the shaft tip 19c of the screw element 19, the (interlocking) connection of the plug-in pin 21 and of the screw boss 20 can be also be disconnected as the screw element 19 glides out of the screw boss 20. In addition, the thread 24 can extend over both shaft portions 27a, 27b, i.e., over the entire threaded or screw shaft 19b.

In summary, the invention relates to a door module 1 for a vehicle door of a motor vehicle, including a support panel 2 having a cable drive 3 of a window lifter which is mounted or can be mounted thereon, wherein the cable drive 3 is coupled to a cable drum 4 for a pull cable 6 which is connected or can be connected to a pane carrier 9 (which is guided with or without a rail). The door module 1 also has a first housing part 5a, which accommodates the cable drum 4 and has through-openings 18 for screw elements 19, and a second housing part 5b, which is associated with the cable drive 3 and has screw bosses 20 for the screw elements 19, the screw bosses corresponding to the through-openings 18, wherein the first housing part 5a is arranged on a first panel face N and the second housing part 5b is arranged on a second panel face T of the support panel 2, and wherein the screw element 19 has a screw head 19a having a first tool receptacle 25 and a threaded shaft 19b with a shaft tip 19c and a second 27 tool receptacle 26 on or in the shaft tip 19c, and therefore the screw element 19 can be actuated, in particular loosened, on the second panel face T in order to uninstall the second housing part 5b, which is screwed together with the first housing part 5a.

The invention is not limited to the above-described exemplary embodiments. Rather, other variants of the invention can also be derived therefrom by a person skilled in the art without departing from the subject matter of the invention. In particular, all individual features described in conjunction with the exemplary embodiment are also combinable with one another in another way without departing from the subject matter of the invention.

### LIST OF REFERENCE SIGNS

1 door module
2 support panel/functional support
3 cable drive
4 cable drum
5 housing assembly
5a first housing part/cable drive housing
5b second housing part/gear mechanism housing
6 pull cable
6a incoming or outgoing cable portion
6b outgoing or incoming cable portion
7 deflection element
8 rail contour/guide rail
9 driver/rail slider
10 driver contour
11 spring element
12 bearing journal
13 drive journal
14 gear mechanism
15 electric motor
16 motor/gear mechanism interface
17 plug-in connection
18 through-opening
19 screw element
19a screw head
19b threaded shaft
19c shaft tip
20 screw boss
21 plug-in pin
22 insertion pockets
23 plug-through opening
24 thread
25 tool receptacle/primary drive
26 tool receptacle/secondary drive
27a first shaft portion
27b second shaft portion
d_{l,2} outer/screw/shaft diameter
D axis of rotation
N wet chamber
T dry chamber

1-10. (canceled)

11. A door module for a vehicle door of a motor vehicle, the door module comprising:
a support panel including a first panel side, a second panel side disposed opposite said first panel side, a first housing part disposed on said first panel side, and a second housing part disposed on said second panel side;
said first housing part having a plurality of through-openings, and said second housing part having a plurality of screw bosses corresponding to said plurality of through-openings;
a pane carrier;
a cable drum for a pull cable connected or configured to be connected to said pane carrier, said cable drum being rotatably accommodated on said first housing part;
a cable drive of a window lifter, said cable drive being mounted or configured to be mounted on said support panel and associated with said second housing part, and said cable drive being coupled to said cable drum; and
a plurality of screw elements to be accommodated by said plurality of screw bosses and said plurality of through-openings, each of said screw elements having a screw head with a first tool receptacle and a threaded shaft having a shaft tip and a second tool receptacle on or in said shaft tip, permitting said screw elements to be actuated and loosened from said second panel side to uninstall said second housing part being screwed together with said first housing part.

12. The door module according to claim 11, wherein said support panel has a plurality of plug-through openings for said plurality of screw elements, said plurality of plug-through openings being aligned with said plurality of through-openings in said first housing part and with said plurality of screw bosses in said second housing part.

13. The door module according to claim 11, wherein said first panel side is a wet-chamber side, said second panel side is a dry-chamber side, said first housing part accommodating said cable drum is disposed on said wet-chamber side, and said second housing part is disposed on said dry-chamber side.

14. The device according to claim 11, wherein said first housing part has at least one of:
a plurality of lug-in pins penetrated by said plurality of through-openings for said plurality of screw elements, or
at least one of said plurality of through-openings or said plurality of plug-in pins disposed in a region of corners of a triangle or positioned in a triangular arrangement.

15. The door module according to claim 14, wherein said plurality of through-openings are three through-openings, and said plurality of plug-in pins are three plug-in pins.

16. The door module according to claim 11, wherein at least one of:
said plurality of screw bosses in said second housing part each have an insertion pocket for accommodating a respective corresponding plug-in pin on said first housing part, or
said plurality of screw bosses of said second housing part are disposed in a region of corners of a triangle or positioned in a triangular configuration.

17. The door module according to claim 16, wherein said plurality of screw bosses disposed in the region of the corners of the triangle or positioned in the triangular configuration are three screw bosses.

18. The door module according to claim 11, wherein said plurality of screw elements each have at least one of:
a self-cutting or metric thread, or
a first shaft portion of said threaded shaft adjoining said screw head and having a first outer or shaft diameter, and a second shaft portion leading into said shaft tip and having a second outer or screw diameter.

19. The door module according to claim 18, wherein said first outer or shaft diameter of said first shaft portion is smaller than said second outer or screw diameter of said second shaft portion.

20. The door module according to claim 11, wherein at least one of:
said second tool receptacle on said shaft tip of said plurality of screw elements is configured as an internal or external polygon, or
said second tool receptacle on said shaft tip of said plurality of screw elements has an inner diameter of 3 mm to 5 mm.

21. The door module according to claim 20, wherein said inner diameter of said second tool receptacle is 3.5±0.5 mm.

22. The door module according to claim 11, wherein upon loosening said plurality of screw elements by engaging said second tool receptacle on said shaft tip of said plurality of screw elements, a connection or an interlocking connection of or on a screw connection is loosened and said plurality of screw elements is captively held in said plurality of through-opening or in a plurality of plug-in pins on said first housing part.

23. A housing assembly for a door module of a vehicle door of a motor vehicle, the housing assembly comprising:
a first housing part provided and configured to accommodate a cable drum of a cable window lifter, said first housing part having a plurality of through-openings;
a second housing part associated with a cable drive, said second housing part having a plurality of screw bosses corresponding to said plurality of through-openings in said first housing part; and
a plurality of screw elements corresponding to said plurality of screw bosses, said screw elements each having a threaded shaft, two shaft ends and one respective tool receptacle at each of said shaft ends, permitting said screw elements to be accessed and actuated from both of said shaft ends.

24. The housing assembly according to claim 23, wherein said screw elements are accessible and actuatable from a rear face of said first housing part and from said second housing part, for screwing together or loosening a screw connection.
